(19) United States
(12) Patent Application Publication
(10) Pub. No.: US 2011/0210274 A1
(43) Pub. Date: Sep. 1, 2011

(54) METHOD FOR ALLEVIATION OF MENOPAUSAL SYMPTOMS

(76) Inventors: Frieder K. Kempe, Coquitlam (CA); Don Nixdorf, Burnaby (CA)

(21) Appl. No.: 12/672,645

(22) PCT Filed: Sep. 12, 2008
(86) PCT No.: PCT/CA2008/001638

§ 371 Date: Feb. 8, 2010

Related U.S. Application Data
(60) Provisional application No. 60/972,148, filed on Sep. 13, 2007.

(51) Int. Cl. G21F 3/02

(52) U.S. Cl. 250/516.1; 250/519.1

(57) ABSTRACT

A method of alleviating menopausal symptoms in a woman is disclosed wherein a significant portion of the woman's body is shielded from high frequency electromagnetic radiation for a period of time sufficient to reduce the symptoms while permitting low frequency electromagnetic radiation to reach her body. The method may be accomplished by using a radiation shielding textile as a bed sheet on which the woman sleeps at night or during the day by fashioning a garment from the radiation-shielding textile or using a sheet or cover, or fashioning a wrap. The radiation-shielding textile found to be suitable is a cloth woven of yarn consisting of a textile fibre, such as nylon, and from two to thirty-five percent by weight of electrically conductive filament, preferably stainless steel.

### CROSS REFERENCE TO RELATED APPLICATION

The present application claims the benefits, under 35 U.S.C. §119(e), of U.S. Provisional Application Ser. No. 60/972,148 filed Sep. 13, 2007 which is incorporated herein by this reference.

### TECHNICAL FIELD

The present invention relates to methods of treating and alleviating various symptoms arising from the condition commonly referred to as menopause.

### BACKGROUND

Menopause is the physiological cessation of menstrual cycles in human females caused by lessening amounts of hormones such as estrogen and progesterone in the woman's body. It typically occurs between the ages of 45 and 55. The date menopause occurs is defined as the day after the woman's final menstrual period ceases. “Perimenopause” refers to the time period before and after menopause during which the fluctuation in hormonal levels causes various symptoms in the woman, referred to herein as “menopausal symptoms”. These include vasomotor symptoms such as hot flashes (periods during which the woman experiences a feeling of intense heat with sweating and rapid heartbeat), palpitations and related sleep disturbances; skeletal and muscular symptoms such as muscle, joint and back pain and osteoperosis; psychological symptoms such as anxiety, depression, irritability, memory loss, fatigue, mood swings and loss of concentration; sexual symptoms such as decreased libido, vaginal dryness, inability to reach orgasm and pain during sexual intercourse; skin and soft tissue symptoms such as skin thinning and decreased elasticity, formication and breast atrophy; and urogenital atrophic symptoms such as urgency of urination, incontinence, dryness, itching and bleeding. Various medications are used to treat menopausal symptoms, such as hormone replacement therapy and anti-depressants as well as natural supplements such as black cohosh. Meditation is also practised as a treatment for menopausal symptoms. Existing treatments are not universally or consistently effective in relieving such symptoms.

The co-inventor of the present invention has previously discovered that pain resulting from exposed or damaged nerve ends, commonly referred to as phantom limb pain, can be relieved or alleviated by shielding the painful area with a cloth woven from a yarn containing threads of a conductive metal. As disclosed in U.S. Pat. No. 4,653,473, the contents of which are incorporated herein by reference, which issued on 31 Mar. 1987, the yarn of the cloth used in this previously-discovered method is preferably composed of from 2 to 35% by weight of conductive metal filament, and the balance of natural or synthetic textile fiber such as nylon. The metal may be any conductor, but a stainless steel alloy has been found to be effective.

The co-inventor of the present invention has also discovered that a similar method can be used to alleviate delayed onset muscle soreness as disclosed in U.S. Pat. No. 6,146,351 issued 14 Nov. 2000, the contents of which are incorporated herein by reference. See also Zhang J., Clement D, and Taunton J. “The Efficacy of Farabloc, an Electromagnetic Shield, in Attenuating Delayed-Onset Muscle Soreness” Clin J. Sport Med, 2000 Jan;10(1):15-21. PMID: 106995845 [PubMed-indexed for MEDLINE]. The present co-inventor has also previously discovered that a similar method may be implemented successfully in the treatment of inflammatory diseases, including fibromyalgia in humans and other arthritic and rheumatoid diseases by shielding affected areas from high frequency electromagnetic radiation while not shielding the area from low frequency radiation. See United States published patent application publication no. 2005/0070191 entitled “Method and Article for Treatment of Inflammatory Disease”, the contents of which are incorporated herein by reference.

### SUMMARY OF INVENTION

The present invention provides a method of alleviating symptoms of menopause in a woman comprising shielding a significant portion of the woman's body from high frequency electromagnetic radiation for a period of time sufficient to reduce the symptoms while permitting low frequency electromagnetic radiation to reach the affected areas.

The invention further provides a method of alleviating symptoms of menopause in a woman comprising the steps of: (i) providing a sheet of cloth comprising between two and thirty-five percent by weight of a continuous system of electrically conductive fibres; ii) placing said sheet on said woman's bed and (ii) said woman sleeping at night on top of and/or under said sheet.

The invention further provides a method of alleviating symptoms of menopause in a woman comprising the steps of: (i) providing an article of clothing configured to cover a significant area of the woman's body with a cloth comprising between two and thirty-five percent by weight of a continuous system of electrically conductive fibres; and (ii) the woman wearing said article of clothing over a period of time sufficient to reduce the symptoms.

### BRIEF DESCRIPTION OF DRAWINGS

In drawings which illustrate embodiments of the invention:

FIG. 1 illustrates a bed sheet made from a cloth according to the invention.

FIG. 2 illustrates a cummerbund made from a cloth according to the invention.

### DESCRIPTION

Recently there has been increasing interest in electrobiological effects in humans. The use of low frequency electromagnetic fields to promote bone repair is well established. (See Pilla, “Low-intensity electromagnetic and mechanical modulation of bone growth and repair: are they equivalent?” J Orthrop Asc 2002; 7(3): 420-8). Electroporation, the use of high frequency, high voltage pulsed electrostimulation of cellular tissue to increase the permeability of the cell membrane has become well established and is used to enhance chemotherapy drug delivery (Neumann et al. “Fundamentals of electroporative delivery of drugs and genes” Bioelectrochem Bioenerg 1999 Feb; 48(1): 3-16; Gehl “Electroporation: theory and methods, perspectives for drug delivery, gene therapy and research”, Acta Physiol Scand 2003 Apr; 177(4); 437-47). Recent studies suggest low frequency electromagnetic fields reduce permeability of cell membranes ((Bordiushkov et al. “Structural-Functional changes in lymphocytes and erythrocyte membranes after exposure to alternating magnetic field” Vpor Med Khim 2000 Jan-Feb; 46(1):72-80; Heida et al. “Investigating membrane breakdown of neuronal cells exposed to non-uniform electric fields by finite-element modelling and experiments” IEEE Trans Biomed Eng 2002 Oct; 49(10): 1195-203). The present inventors have discovered that menopausal symptoms are reduced by shielding areas of the woman's body from high frequency electromagnetic fields. It is believed that by blocking high frequency EMF, the same effect on cell membranes is achieved as if low frequency EMF is applied, namely reduced permeability of cell membranes. For purposes of this application, “high frequency electromagnetic fields” means electromagnetic fields having a frequency greater than about 1 megahertz. “Low frequency electromagnetic fields” means electromagnetic fields having a frequency less than about 1 megahertz. This may be accomplished, for example, by clothing the woman in a cover, cummerbund or other form of apparel or wrapping with a sheet of textile where the textile is made from a radiation-shielding textile, or lying at night on a sheet of the radiation-shielding textile. Based on the recent findings regarding electrobiologic effects, it is believed that beneficial results of use of the radiation-shielding textile material may arise from blockage of high frequency EMF to prevent increased permeability of the cell membrane and permitting low frequency EMF to reach the cell membranes to decrease permeability of the cell membranes.

A suitable radiation-shielding textile for the practice of the method of the invention which both provides the appropriate electromagnetic shielding and the comfort of a standard non-metallic textile is a fabric sold under the trade-mark FARABLOC. High frequency electromagnetic fields greater than 1 MHz such as radio waves are completely blocked by double layers of the FARABLOC material. However low frequency EMF are not blocked. The yarn from which the textile is woven is preferably composed of approximately 13% by weight of stainless steel filaments but may be from 2% to 35% by weight of stainless steel filaments. The balance of the yarn is a synthetic nylon fiber such as nylon. The yarn has an electrical conductance of approximately 330 ohms per centimeter. The preferred fabric has a warp of 24.5 threads per centimeter and a woof of 24.5 threads per centimeter but fabrics of other characteristics, such as knitted fabrics also will be effective. The weight of the woven fabric is preferably approximately 180 grams per square meter. The preferred binding is L 1/1—that is, one thread up and one thread down. The fabric may be knitted as well as woven. Other conductive materials would also be suitable for the conductive fibers, such as copper, silver or ceramics. Other natural or synthetic non-conductive fibers would also be suitable to comprise the yarn. It would also be suitable to utilize cloth woven or knitted of alternate threads of conductive and textile fibers.

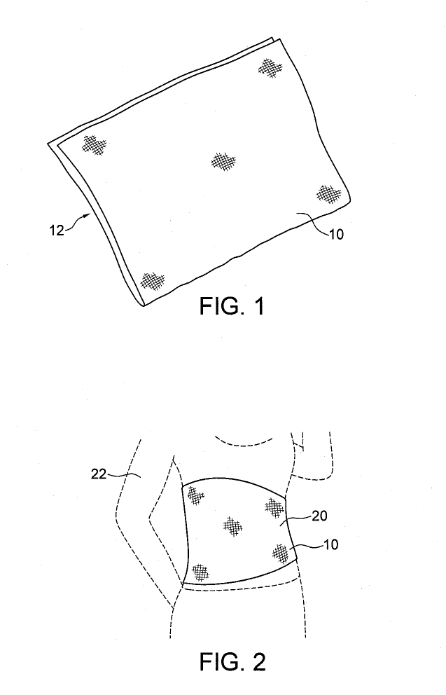

At the basis of the present invention is the discovery that shielding areas of a woman's body from high frequency electromagnetic radiation while permitting low frequency electromagnetic radiation to reach the woman's body has beneficial results in the alleviation of menopausal symptoms. According to the method of the invention, the woman suffering from menopausal symptoms sleeps at night on a bedsheet 12 made from a double layer of FARABLOC material 10 (FIG. 1). The woman preferably sleeps on the sheet of FARABLOC material directly or with an intermediate bedsheet between the woman's body and the FARABLOC material. The method also works if the FARABLOC material is used as the outer sheet or blanket on top of the woman's body or as both the lower sheet and outer sheet thereby covering the woman's body on both sides while sleeping. Instead, or in addition, during the day the woman 22 wears, for example, a cummerbund, as designated by reference numeral 20 in FIG. 2, made from a double layer of FARABLOC material. The longer the period during which the cummerbund is worn, the better the results. The cummerbund 20 need not be constructed entirely of the conductive cloth, but the cummerbund should have a large enough area of the conductive cloth 10 to cover a significant area of the woman's body. While the method preferably uses a cummerbund 20, other forms of apparel such as a shirt, pants or jumpsuit may be used, or a sheet or wrap secured about the woman's body using hook and loop fasteners, for example.

### Case Study 1

In a first study carried out on a woman aged 57, the woman was suffering from hot flashes at night, disrupted sleep and increased sweating at nighttime due to menopause. A double layered sheet of the FARABLOC material was placed on the woman's bed on which she slept. The woman experienced decreased hot flashes and more restful sleep the first night the FARABLOC material was used and relief of the menopausal symptoms was consistent thereafter when she slept on the FARABLOC material. When the FARABLOC material was removed the symptoms began to return, but improved again when the use of the FARABLOC material was resumed.

### Case Study 2

In a second study carried out on a woman aged 52, the woman was suffering from nighttime sweating, general aching at night and disrupted sleep due to menopause. A double layered sheet of the FARABLOC material was placed on the woman's bed on which she slept. After several nights the woman experienced decreased awakening from sleep, decreased sweating at night and decreased general aching. This continued most nights and the woman felt more rested using the FARABLOC material. When the FARABLOC material was removed some symptoms returned, but went away the first night when the use of the FARABLOC material was resumed.

### Case Study 3

In a third study carried out on a woman aged 51, the woman was suffering from hot flashes at night which required changes of sleep apparel, general aching feeling at night and disrupted sleep due to menopause. A double layered sheet of the FARABLOC material was placed on the woman's bed on which she slept. The woman experienced decreased hot flashes on the first night. No further change in sleep apparel due to perspiration was required. The woman experienced decreased general aching and felt more rested when the FARABLOC material was used. The relief of the menopausal symptoms was sustained most nights thereafter when she slept on the FARABLOC material. When the FARABLOC material was removed, some symptoms returned, but went away again the first night when the use of the FARABLOC material was resumed.

### Case Study 4

In a fourth study carried out on a woman aged 54, the woman was suffering from heat waves and sweating day and night due to menopause which required changes of clothing day and night. A double layered sheet of the FARABLOC material was placed on the woman's bed on which she slept. The woman experienced a 90% reduction in heat waves the first night and slept through the night without sweating. This was consistent for 10 nights but during that time during the daytime heat waves continued, causing heavy sweating. The woman then commenced in addition to wear a cummerbund of the FARABLOC material as shown in FIG. 2 during the day. This caused an 80% reduction in the daytime symptoms. The woman experienced the start of heat waves but within 1 or 2 minutes the heat wave did not develop further and hot flashes, hot body-feeling and sweating did not occur. When use of the FARABLOC material was discontinued for one day and night the symptoms returned.

### Case Study 5

In a fifth study carried out on a woman aged 58, the woman was suffering from hot flashes at night, disrupted sleep and increased sweating at night due to menopause. A double layered sheet of the FARABLOC material was placed on the woman's bed on which she slept. On the first night the woman experienced decreased hot flashes, less sleep interruption and more restful sleep. The relief of the menopausal symptoms was consistent thereafter when she slept on the FARABLOC material.

When the FARABLOC material was removed, symptoms began to return, but improved again the first night when the use of the FARABLOC material was resumed.

As will be apparent to those skilled in the art in the light of the foregoing disclosure, many alterations and modifications are possible in the practice of this invention without departing from the spirit or scope thereof. For example, while a woven cloth has been specified in the description of the preferred embodiment, it will be apparent to those skilled in the art that a non-woven cloth having a grid of conductive filaments will also operate effectively in the method of the invention while retaining the qualities of a normal fabric. It will also be apparent that many variations in the type of conductive thread or yarn and textile fibers used in the cloth and in the manner of weaving or knitting the cloth are possible in the practice of this invention without departing from the scope thereof. Accordingly, the scope of the invention is to be construed in accordance with the substance defined by the following claims.

What is claimed is:

1. A method of alleviating menopausal symptoms in a woman comprising shielding significant portions of the woman's body from high frequency electromagnetic radiation, while not shielding the woman's body from low frequency electromagnetic radiation, for a period of time sufficient to reduce the symptoms.

2. The method of claim 1 wherein said high frequency electromagnetic radiation has a frequency greater than about 1 megahertz.

3. The method of claim 2 wherein said low frequency electromagnetic radiation has a frequency less than about 1 megahertz.

4. The method of claim 1 wherein said shielding is accomplished by covering a significant area of the woman's body with a radiation-shielding textile for a period of time sufficient to reduce said symptoms.

5. The method of claim 4 wherein said radiation-shielding textile comprises between two and thirty-five percent by weight of a continuous system of electrically conductive fibers and the remainder of non-conductive fibers.

6. The method of claim 5 wherein said radiation-shielding textile is a woven cloth and said electrically conductive fibers are stainless steel fibers.

7. The method of claim 5 wherein said radiation-shielding textile is a woven cloth and said electrically conductive fibers are formed of a material selected from the group copper, silver or ceramic.

8. The method of claim 5 wherein said radiation-shielding textile is a knitted fabric and said electrically conductive fibers are stainless steel fibers.

9. The method of claim 5 wherein said radiation-shielding textile is a knitted fabric and said electrically conductive fibers are formed of a material selected from the group copper, silver or ceramic.

10. The method of claim 8 wherein said radiation-shielding textile comprises about thirteen percent by weight of a continuous system of electrically conductive fibers and the remainder of non-conductive fibers.

11. A method of alleviating symptoms of menopause in a woman comprising the steps of
(i) providing a sheet of a high-frequency electromagnetic radiation-shielding cloth which does not shield low frequency electromagnetic radiation;
ii) placing said sheet on said woman's bed; and
iii) said woman sleeping at night on top of and/or under said sheet.

12. The method of claim 11 wherein radiation-shielding cloth comprises between two and thirty-five percent by weight of a continuous system of electrically conductive fibers and the remainder of non-conductive fibers.

13. The method of claim 12 wherein said electrically conductive fibers are formed of a material selected from the group copper, silver or ceramic.

14. The method of claim 12 wherein said radiation-shielding cloth comprises about thirteen percent by weight of a continuous system of electrically conductive fibers and the remainder of non-conductive fibers.

15. A method of alleviating menopausal symptoms in a woman comprising the steps of:
i) providing an article of clothing configured to cover a significant portion of the woman's body with a high-frequency electromagnetic radiation-shielding cloth which does not shield low frequency electromagnetic radiation; and
ii) said woman wearing said article of clothing over a period of time sufficient to reduce said pain.

16. The method of claim 15 wherein radiation-shielding cloth comprises between two and thirty-five percent by weight of a continuous system of electrically conductive fibers and the remainder of non-conductive fibers.

17. The method of claim 16 wherein said electrically conductive fibers are formed of a material selected from the group copper, silver or ceramic.

18. The method of claim 16 wherein said radiation-shielding cloth comprises about thirteen percent by weight of a continuous system of electrically conductive fibers and the remainder of non-conductive fibers.
